(19) United States
(12) Patent Application Publication
(10) Pub. No.: US 2015/0193034 A1
(43) Pub. Date: Jul. 9, 2015

(54) TOUCH SENSOR

(71) Applicant: SAMSUNG ELECTRO-MECHANICS CO., LTD., Gyeonggi-Do (KR)

(72) Inventors: Gwan Ha JEONG, Gyeonggi-Do (KR); Hyung Ho KIM, Gyeonggi-Do (KR)

(73) Assignee: SAMSUNG ELECTRO-MECHANICS CO., LTD., Gyeonggi-Do (KR)

(21) Appl. No.: 14/326,793

(22) Filed: Jul. 9, 2014

(30) Foreign Application Priority Data
Jan. 8, 2014 (KR) 10-2014-0002483

(51) Int. Cl. G06F 3/041; G06F 1/16

(52) U.S. Cl. CPC G06F 3/041; G06F 1/16

(57) ABSTRACT

Embodiments of the invention provide a touch sensor, which includes a base substrate, and an electrode pattern, which is formed on the base substrate and is formed in a mesh pattern formed by intersecting at least one metal wire. Dot patterns are formed on a region between the metal wires.

### CROSS REFERENCE TO RELATED APPLICATION

This application claims the benefit of and priority under 35 U.S.C. §119 to Korean Patent Application No. KR 10-2014-0002483, entitled “TOUCH SENSOR,” filed on Jan. 8, 2014, which is hereby incorporated by reference in its entirety into this application.

### BACKGROUND

1. Field of the Invention

The present invention relates to a touch sensor.

2. Description of the Related Art

With the development of computers using a digital technology, computer-aided devices have also been developed, and personal computers, portable transmitters and other personal information processors execute processing of texts and graphics using a variety of input devices such as a keyboard and a mouse.

With the rapid advancement of an information-oriented society, the use of computers has gradually been expanded; however, it is difficult to efficiently operate products using only a keyboard and a mouse, which currently serve as input devices. Therefore, the necessity for a device, which has a simple configuration and less malfunction and is configured for anyone to easily input information, has increased.

In addition, technologies for input devices have progressed toward techniques related to, for example, high reliability, durability, innovation, designing, and processing, as non-limiting examples, in addition to satisfying general functions. To this end, a touch sensor has been developed as input devices capable of inputting information, such as texts and graphics.

The touch sensor is a device which is mounted on a display surface of a display such as an electronic organizer, a flat panel display device including, for example, a liquid crystal display (LCD) device, a plasma display panel (PDP), and an electroluminescence (El) element, as non-limiting examples, and a cathode ray tube (CRT) to be used to allow a user to select desired information while viewing the display.

US Patent Publication No. 2013/0180841 describes a conventional touch sensor, which has a problem in that when the metal electrode is used as the electrode pattern of the touch sensor, the opaque electrode pattern is visualized. Various methods of reducing the visibility of the opaque electrode pattern have been introduced, but the methods do not easily solve the problem of improvement in conductivity using the metal electrode and the reduction in visibility of the metal electrode.

### SUMMARY

Accordingly, embodiments of the invention have been made to provide a touch sensor capable of reducing visibility of an electrode pattern formed in a mesh pattern.

According to an embodiment of the invention, there is provided a touch sensor, including a base substrate, and an electrode pattern, which is formed on the base substrate and is formed in a mesh pattern formed by intersecting at least one metal wire. According to an embodiment, dot patterns are formed on a region between the metal wires.

According to an embodiment, the electrode pattern is provided with a cut portion, which is formed on the metal wire to electrically insulate between at least two electrode patterns.

According to an embodiment, a diameter of the dot pattern is formed to be smaller than a spaced distance from the cut portion.

According to an embodiment, dot patterns are spaced apart from the metal wires and are formed to be spaced apart from each other at regular intervals in a formation direction of the metal wires.

According to an embodiment, the dot pattern includes at least one dot and the dots are formed at regular intervals in a direction in which the metal wires are formed.

According to an embodiment, the dot pattern includes dots in a range from 1 to 2000 on a unit area of 1 mm×1 mm on the electrode pattern.

According to an embodiment, when a line width of the metal wire is 3 μm to 8 μm, dots in a range from 50 to 2000 are formed on a unit area of 1 mm×1 mm on the electrode pattern.

According to an embodiment, an area of the metal wire and the dot pattern is formed to be 5% or less in the entire area of an activation region of the touch sensor in which the electrode pattern is formed.

According to an embodiment, the dot pattern is formed to have a diameter corresponding to a line width of the metal wire.

According to an embodiment, a line width of the metal wire is formed to be smaller than a spaced width of the cut portion and the line width of the metal wire is formed to be larger than or equal to a diameter of the dot pattern.

According to an embodiment, the dot pattern is made of copper (Cu), aluminum (Al), gold (Au), silver (Ag), titanium (Ti), palladium (Pd), chromium (Cr), nickel (Ni), or a combination thereof.

According to an embodiment, the dot pattern is made of an insulating material.

According to an embodiment, the dot pattern includes at least one dot and a diameter of the dot is formed to be in a range from 0.1 μm to 10 μm.

According to an embodiment, the dot pattern includes at least one dot and the dot is formed in a polygonal shape or in a combination of at least two polygonal shapes.

According to an embodiment, the diameter of each dot is formed to be in a range from 0.1 μm to 10 μm and the diameter passes through a center of the dot and is defined by a line segment connecting two points, which are farthest spaced apart from each other on a circumference of the dot.

According to an embodiment, the dot pattern includes at least one dot and the dots are formed to be spaced from the metal wires and are formed to be spaced apart from each other at any interval on the dot pattern.

According to an embodiment, the dot pattern includes a plurality of dots, each dot is formed in a circular shape, a polygonal shape, or a combination thereof, and the plurality of dots are formed in different shapes.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of a touch sensor according to an embodiment of the invention.

FIG. 2 is a plan view of a mesh pattern according to an embodiment of the invention.

FIG. 3 is a plan view of an electrode pattern formed in the mesh pattern according to an embodiment of the invention.

FIG. 4 is a diagram illustrating dots formed on a unit area of the mesh pattern according to an embodiment of the invention.

FIG. 5 is a diagram illustrating various shapes of the dots according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

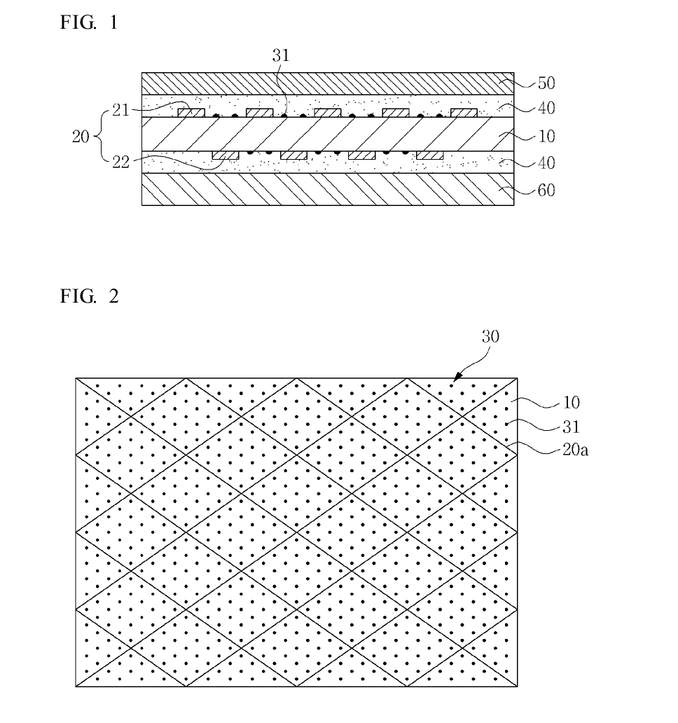

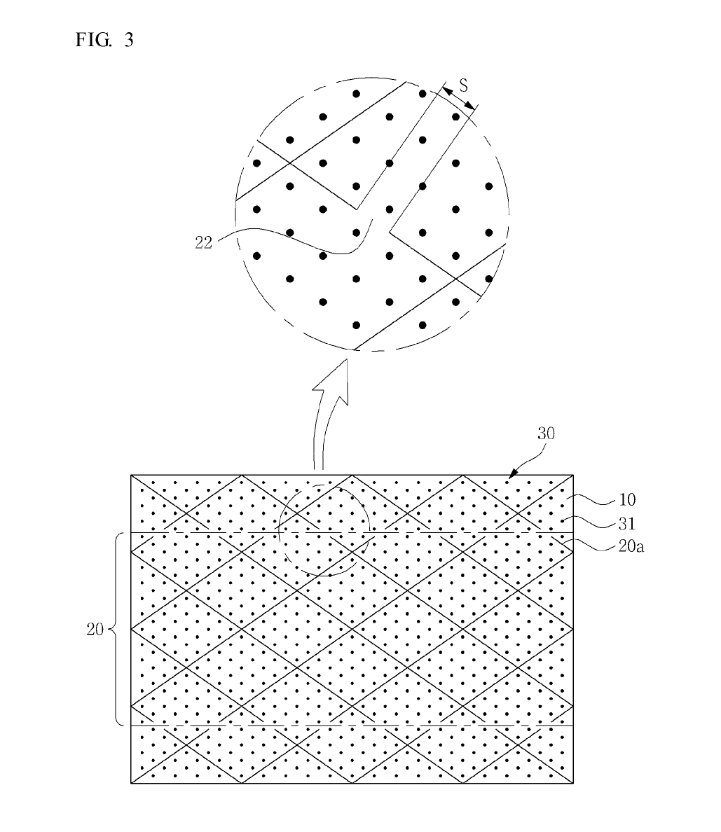

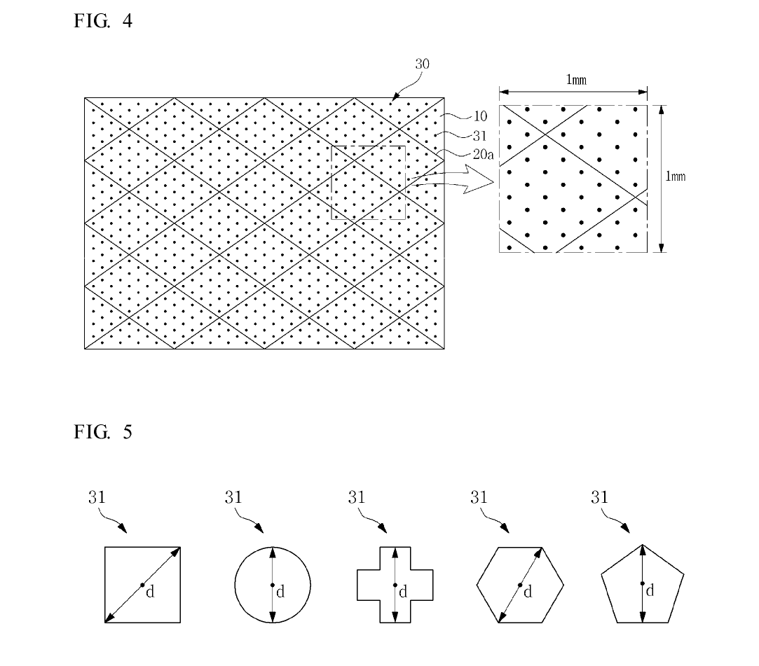

FIG. 1 is a cross-sectional view of a touch sensor according to an embodiment of the invention, FIG. 2 is a plan view of a mesh pattern according to an embodiment of the invention, FIG. 3 is a plan view of an electrode pattern formed in the mesh pattern according to an embodiment of the invention, FIG. 4 is a diagram illustrating dots formed on a unit area of the mesh pattern according to an embodiment of the invention, and FIG. 5 is a diagram illustrating various shapes of the dots according to an embodiment of the invention.

As illustrated in FIG. 1, in the touch sensor, according to an embodiment of the invention, first electrode patterns 21 and second electrode patterns 22 are formed on both surfaces of a base substrate 10 and a display unit 60 is bonded to a lower portion of the second electrode pattern 22 through an adhesive layer 40. Further, a window substrate 50 as a protective substrate for protecting a touch sensor is further bonded to an outermost layer of the first electrode pattern 21 with the adhesive layer 40. However, the various embodiments of the invention described herein are not limited to this specific structure, as the electrode pattern 20 to be described below includes the first electrode patterns 21 and the second electrode patterns 22 and a material and a related structure thereof being substantially the same and therefore a separate description thereof will be omitted.

According to an embodiment, the window substrate 50 is formed at an outermost side of the touch sensor to serve to protect the touch sensor 1 from an external environment. According to an embodiment, the window substrate 50 is made of a transparent material to implement visibility of a user, but any material having a predetermined strength or more, such as glass or tempered glass, as non-limiting examples. Although not illustrated in this embodiment of the invention, the touch sensor 1 may also be implemented by directly forming the electrode pattern 20 on the window substrate 50 and even in this case, embodiments of invention may be applied to reduce the visibility of the electrode pattern 20.

According to an embodiment, the display unit 60 is a display device, which visually outputs data on a screen and is, for example, a cathode ray tube (CRT), a liquid crystal display (LCD), a plasma display panel (PDP), a light emitting diode (LED), and an organic light emitting diode (OLED), as non-limiting examples.

According to an embodiment, the touch sensor, according to an embodiment of the invention includes the base substrate 10, the electrode pattern 20, which is formed on the base substrate 10 and is formed in a mesh pattern formed by intersecting at least one metal wire 20a, and a dot pattern 30 formed on a region between the metal wires 20a.

According to an embodiment, the dot pattern 30 includes at least one dot 31 in a predetermined pattern at a constant interval or an irregular interval. According to an embodiment, the dot pattern 30 has a specific shape of pattern, but may have more various shapes of pattern.

According to an embodiment, the base substrate 10 of the touch sensor 1 is made of any material, which has transparency and outputs an image of a display unit 60 without being particularly limited as a material, which has a predetermined strength, but is made of, for example, polyethylene terephthalate (PET), polycarbonate (PC), poly methyl methacrylate (PMMA), polyethylene naphthalate (PEN), polyethersulpon (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass, as non-limiting examples. Further, one surface of the base substrate 10 is formed with the electrode pattern 20 and therefore a surface treating layer is formed by performing the one surface of the base substrate 10 with, for example, high frequency treatment, primer treatment, as non-limiting examples, to improve an adhesion between the base substrate 10 and the electrode pattern 20.

According to an embodiment, the electrode pattern 20 is formed on the one surface of the base substrate 10 and when a touch signal is input by the user, the touch signal is generated and therefore a controller (not illustrated) recognizes touched coordinates. The case in which the electrode pattern 20, according to an embodiment of the invention, is formed in the mesh pattern formed by intersecting the metal wires 20a each other is described, but it is obvious to those skilled in the art that the electrode pattern 20 may be applied as described above and changed in design to reduce the visibility of various regular and irregular patterns using an opaque metal electrode.

According to an embodiment, the electrode pattern 20 is formed in the mesh pattern, for example, using copper (Cu), aluminum (Al), gold (Au), silver (Ag), titanium (Ti), palladium (Pd), chromium (Cr), nickel (Ni), or a combination thereof. Meanwhile, even in the case in which the electrode pattern 20 is also formed using metal oxides, such as metal, silver (Ag), and indium thin oxide (ITO) formed by exposing/developing a silver salt emulsion layer or a conductive polymer, such as PEDOT/PSS having excellent flexibility and a simple coating process, various embodiments of the invention are provided to further reduce the visibility of the electrode pattern 20. However, yet another embodiment of the invention may be used to reduce the visibility of the electrode pattern 20 made of the opaque metal.

According to an embodiment, the dot pattern 30 is formed by disposing at least one dot 31 on the region between the plurality of metal wires 20a forming the mesh pattern of the electrode pattern 20. Herein, when the dot 31 is made of the same material as the metal wire 20a or a metallic material, it is preferable that the dot 31 is disposed at a position spaced apart from the metal wire 20a for electrical insulation.

As illustrated in FIG. 2, the dot 31 forming the dot pattern 30 is also formed in plural in one direction at a predetermined interval, whereby the formation direction of the dot 31 is irregular or the formation interval thereof is variously controlled, which is included in the technical spirit of the various embodiments of the invention, and various shapes forming the dot pattern 30 is not limited to the one illustrated in FIG. 2.

According to an embodiment, when at least two electrode patterns 20 formed in the mesh pattern are disposed on the one surface of the base substrate 10, as illustrated in FIG. 3, a cut portion 20b is formed on the metal wire 20a to keep the insulation between the electrode patterns 20. In this case, when the dots 31 forming the dot pattern 30 are made of a metal material, the dots 31 are formed to have a diameter d smaller than a spaced width S of the cut portion 20b of the metal wire 20a to more effectively keep the electrical reliability of the electrode pattern 20. Further, even in the case of using the dots 31 made of an insulating material which have a non-conductivity, when a dot 31 is coupled with the metal wire 20a, a line width of the metal wire 20a is visualized more thickly and thus the visibility of the electrode pattern 20 is increased, such that the dots 31 are formed to be spaced apart from each other so as not to be overlapped or connected with the metal wires 20a.

In particular, considering the relationship of the diameter d of the dot 31, the line width of the metal wire 20a, and the spaced width S of the cut portion 20b, the line width of the metal wire 20a is formed to be smaller than the spaced width S of the cut portion 20b and the diameter d of the dot 31 is formed to be smaller than or equal to the line width of the metal wire 20a. In this relationship, the dot pattern 30 is more effective in reducing the visibility of the electrode pattern 20 formed of the metal wire 20a and the final touch sensor is recognized within the effective range of transmittance by the user.

As further illustrated in FIG. 2, the dot pattern 30 is spaced apart from the metal wire 20a and is formed to be spaced apart from the metal wire 20a at regular intervals. The dots 31 included in the dot pattern 30 are formed to be disposed in a direction, in which the metal wire 20a is formed at regular intervals. As illustrated in FIG. 4, the dot pattern 30 is formed to include the dots 31 in a range from 1 to 2000 on a unit area (1 mm×1 mm), thereby more effectively reducing the visibility of the electrode pattern 20. The smaller number of dots 31 is difficult to reduce the visibility of the mesh pattern and when the larger number of dots 31 is formed, an aperture ratio is small and thus the transmittance, which affects the overall visibility.

According to an embodiment, the dot 31 has a partial connection with the line width of the metal wire 20a. The diameter of the dot 31 is formed to have the same line width as the metal wire 20a.

According to an embodiment, the line width of the metal wire 20a is formed at 3 μm to 8 μm and in this case, and at least one embodiment provides the dots 31 in a range from 50 to 2000 are formed on a unit area (1 mm×1 mm).

According to an embodiment, when the line width of the metal wire 20a is formed at 3 μm, the number of dots 31 is formed to be in a range from 1 to 1700 and when the line width of the metal wire 20a is formed at 5 μm, the number of dots 31 is formed to be in a range from 1 to 450. Further, when the line width of the metal wire 20a is formed at 8 μm, the dot 31 is formed to be in a range from 1 to 84 and the line width of the metal wire 20a and the diameter of the dot 31 are properly disposed, such that the visibility of the electrode pattern 20 is properly reduced within the range in which the overall transmittance of the touch sensor is not affected.

According to an embodiment, the diameter of the dots 31 forming the dot pattern 30 is formed to be in a range from 0.1 μm to 10 μm, in which the diameter means a diameter in the case of a circle and in the shape other than the circle, is defined by a line connecting two points around the dot 31 formed at a longest distance of the shape of the dot 31 as a line segment passing through a central point of the shape of the dot 31 (see d of FIG. 5).

As illustrated in FIG. 5, the dot 31 is formed to have a circular shape, a polygonal shape, or a shape depending on the combination thereof, and the plurality of dots 31 are formed to have different shapes, thereby more effectively reducing the visibility of the electrode pattern 20.

Unlike the embodiments illustrated in FIGS. 2 to 4, the dots 31 are also formed in a random dot pattern 30 by varying the respective spaced distances at which the individual dots 31 are formed. However, even in this case, properly controlling the number of dots 31 per the unit area is already described so that the electrode pattern 20 is not visualized clearly due to the difference in the spaced distance and therefore the detailed description thereof will be omitted.

According to an embodiment, the method for forming the electrode pattern 20 or the dot pattern 30 is not particularly limited, but the dot pattern 30 may be formed by a dry process, a wet process, or a direct patterning process depending on the formation material. Here, the dry process includes, for example, sputtering or evaporation, as non-limiting examples, the wet process includes, for example, dip coating, spin coating, roll coating, or spray coating, as non-limiting examples, and the direct patterning process includes, for example, screen printing, gravure printing, or inkjet printing, as non-limiting examples.

Further, a photosensitive material is applied on the electrode pattern 20 on the substrate by using photolithography and light is irradiated thereto using a mask formed in a desired pattern. In this case, a developing process for forming a desired pattern by removing a photosensitive material portion to which light is irradiated with a developer or removing a portion to which light is not irradiated with a developer is conducted. Next, the photosensitive material is formed in a specific pattern, the remaining portion is removed with an etchant using the photosensitive material using a resist, and then the photosensitive material is removed, such that the electrode pattern 20 or the dot pattern 30 having the desired pattern may be manufactured.

According to the various embodiments of the invention, it is possible to more improve the visibility of the display device including the touch sensor by reducing the visibility of the electrode pattern formed in the mesh pattern.

Further, according to the various embodiments of the invention, it is possible to prevent the electrode pattern from being visualized by forming the dot pattern on the mesh pattern so as to reduce the visibility of the mesh pattern of the opaque metal electrode forming the electrode pattern.

Further, according to the various embodiments of the invention, it is possible to more effectively reduce the visibility of the electrode pattern by changing the shapes of the plurality of dots forming the dot pattern and changing the degree of freedom of the disposition of the dots.

Further, according to the various embodiments of the invention, it is possible to prevent the moiré phenomenon from occurring and reduce the visibility of the electrode pattern of the touch sensor when the electrode pattern is combined with the display, by forming the dot pattern of the same metal material as the material forming the electrode pattern to prevent the shape of the mesh pattern to be intuitively visualized.

Further, according to the various embodiments of the invention, it is possible to more effectively prevent the moiré phenomenon from occurring by forming the dots forming the dot pattern in the random pattern or making the shapes of each dot different.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a base substrate; and
an electrode pattern which is formed on the base substrate and is formed in a mesh pattern formed by intersecting at least one metal wire,
wherein dot patterns are formed on a region between the metal wires.

2. The touch sensor as set forth in claim 1, wherein the electrode pattern is provided with a cut portion, which is formed on the metal wire to electrically insulate between at least two electrode patterns.

3. The touch sensor as set forth in claim 2, wherein a diameter of each dot pattern is formed to be smaller than a spaced distance from the cut portion.

4. The touch sensor as set forth in claim 1, wherein the dot patterns are spaced apart from the metal wires and are formed to be spaced apart from each other at regular intervals in a formation direction of the metal wires.

5. The touch sensor as set forth in claim 1, wherein the dot pattern comprises at least one dot and the dots are formed at regular intervals in a direction in which the metal wires are formed.

6. The touch sensor as set forth in claim 1, wherein the dot pattern comprises dots in a range from 1 to 2000 on a unit area of 1 mm×1 mm on the electrode pattern.

7. The touch sensor as set forth in claim 1, wherein when a line width of the metal wire is 3 μm to 8 μm, dots in a range from 50 to 2000 are formed on a unit area of 1 mm×1 mm on the electrode pattern.

8. The touch sensor as set forth in claim 1, wherein an area of the metal wire and the dot pattern is formed to be 5% or less in the entire area of an activation region of the touch sensor in which the electrode pattern is formed.

9. The touch sensor as set forth in claim 1, wherein the dot pattern is formed to have a diameter corresponding to a line width of the metal wire.

10. The touch sensor as set forth in claim 2, wherein a line width of the metal wire is formed to be smaller than a spaced width of the cut portion, and
the line width of the metal wire is formed to be larger than or equal to a diameter of the dot pattern.

11. The touch sensor as set forth in claim 1, wherein the dot pattern is made of copper (Cu), aluminum (Al), gold (Au), silver (Ag), titanium (Ti), palladium (Pd), chromium (Cr), nickel (Ni), or a combination thereof.

12. The touch sensor as set forth in claim 1, wherein the dot pattern is made of an insulating material.

13. The touch sensor as set forth in claim 1, wherein the dot pattern comprises at least one dot and a diameter of the dot is formed to be in a range from 0.1 μm to 10 μm.

14. The touch sensor as set forth in claim 1, wherein the dot pattern comprises at least one dot and the dot is formed in a polygonal shape or in a combination of at least two polygonal shapes.

15. The touch sensor as set forth in claim 10, wherein the diameter of the dot is formed to be in a range from 0.1 μm to 10 μm and the diameter passes through a center of the dot and is defined by a line segment connecting two points which are farthest spaced apart from each other on a circumference of the dot.

16. The touch sensor as set forth in claim 1, wherein the dot pattern comprises at least one dot and the dots are formed to be spaced from the metal wires and are formed to be spaced apart from each other at any interval on the dot pattern.

17. The touch sensor as set forth in claim 1, wherein the dot pattern comprises a plurality of dots, the dot is formed in a circular shape, a polygonal shape, or a combination thereof, and the plurality of dots are formed in different shapes.
